(19) United States
(12) Patent Application Publication
(10) Pub. No.: US 2005/0178294 A1
(43) Pub. Date: Aug. 18, 2005

(54) System for recycling wet concretre into precast structures and structures formed thereby

(76) Inventor: Erik Straub, Easton, MD (US)

Correspondence Address: ROYAL W. CRAIG;A PROFESSIONAL CORPORATION, SUIT 153, 10 NORTH CALVER STREET, BALTIMORE, MD, 21202, US

(21) Appl. No.: 11/032,675

(22) Filed: Jan. 10, 2005

Related U.S. Application Data
(60) Provisional application No. 60/535,450, filed on Jan. 8, 2004.

(51) Int. Cl. C04B 16/08; C04B 20/00; C04B 38/00

(52) U.S. Cl. 106/675

(57) ABSTRACT

A system for recycling excess wet concrete (slump) from ready-mix cement trucks, including a method and apparatus. The method comprising constructing a casting bed to create a plurality of molds to make pre-cast cement planks; inserting into each mold a reinforcing structure and either a lifting handle or a sleeve to create a pre-cast hole to receive a lifting handle; pouring excess slump from ready-mix concrete trucks into the molds; screeding, floating and finishing the slump; removing the reinforced planks from the casting bed; and, selling the planks. The apparatus is a casting bed including a floor, support structures, perimeter walls, and dividers to create molds for 1′ by 12′ by ½′ ready-to use reinforced planks.

### CROSS-REFERENCE O RELATED APPLICATION(S)

The present application derives priority from U.S. Provisional Patent Application No. 60/535,450 filed: Jan. 8, 2004.

### BACKGROUND OF THE INVENTION

1. Field of the Invention

The present invention relates to efficiently recycling concrete waste from ready-mix cement trucks. More particularly, the present invention relates to a system, including a method and apparatus, for recycling excess wet concrete into ready-to-use pre-cast structures (and the structures formed thereby) by the use of reinforced molds. Each day-end supply of residual concrete waste from the ready-mix cement trucks is evacuated into the mold, and the mold builds up over time into a useable precast structure.

2. Discussion of the Background.

Often times ready-mix concrete trucks return to the cement yard at the end of the work day with relatively large amounts of excess fresh concrete. This excess fresh concrete must be disposed of or recycled in some manner, so that the cement trucks may be cleaned for the next day's operations.

The typical disposal process has long involved wetting down the concrete within the mixing truck itself to significantly dilute it, and then dumping the wet concrete. This wet concrete is then held in a bin for approximately five days, during which time the particulate separates from the water. After separation of the excess water, the solid material is moved to a drying bin and after some period it is transported to a landfill. This disposal process results in a significant waste of refuse solid material, and a large added cost of transportation and disposal of the refuse solid material. Moreover, cities are now beginning to wrestle with the storage problem of refuse solid material inasmuch as vast piles of it are collecting at many landfills.

As a result, a number of processes have been attempted to recycle the residual concrete. Generally all of these efforts have been directed toward recovery of the concrete aggregate (landfill material).

Another known method for recycling excess fresh cement includes having cement truck operators dump the excess concrete into on-site molds. Once the concrete hardens it is removed from the mold and fed into a cement breaking device. The concrete is broken or ground into small pieces which are sold to construction sites for use as base fill for foundation, sub-foundation or roadbed projects. For example, the Grasan Equipment Company, Inc., manufactures a road-portable concrete recycling plant that includes an impactor crushing plant and screen, as well as a front-end loader. It advertises the system as capable of producing rubble suitable for fill and base for construction projects such as buildings, parking lots, roads and streets, and pipe and drain ducts.

Other examples recycling excess concrete by forming aggregate are found in the following patents. U.S. Pat. No. 5,766,524 to Rashwan et al. issued Jun. 16, 1998, discloses a method and apparatus for the reclamation of excess concrete returned to the cement yard by cement delivery trucks. Particularly, upon returning the cement yard, the trucks empty the residual concrete into hoppers that dispense the leftover concrete into molds designed to produce blocks of concrete suitable for regrinding into aggregate. The concrete is held in the molds for a period of time to allow it to set. Once set, the concrete for blocks are separated from the molds. The molded concrete blocks are then delivered to a grinding station where they are ground into aggregate of selected size and return to the concrete mixing operation. Additionally, any water that separates during the molding operation is subject to a settling operation to settle fine particles and the decanted water is then stored in a suitable reservoir for reuse, for example, in washing out the trucks. U.S. Pat. No. 3,786,997 to Viner issued on Jan. 22, 1974, discloses a wet concrete reclamation method and apparatus in which unused concrete is poured is poured into a formed and then crushed into little pieces. U.S. Pat. No. 6,231,663 to Catterton et al. issued on May 15, 2001, discloses a method for recycling discarded hard concrete items by blending bits of crushed old concrete into new batches of concrete.

Unfortunately, the resulting aggregate from such recycling systems often times does not meet federal, state, or local structural building code requirements. For example, federal and many state codes require the use of native quarry stones as aggregate for roadbeds. Furthermore, this process of hardening the concrete and grinding is time consuming and expensive and, therefore, not very profitable.

Other inventions have been directed towards prevention of job-site dumping of concrete waste, but do not solve the ultimate problem of disposal or recycling of excess concrete. U.S. Pat. No. 6,039,468 to Kowalcyzk issued on Mar. 21, 2000, discloses a washout bucket assembly which is connected to the tag axle of a cement mixer truck and is used to capture waste water and concrete material resulting from the on-site clean-up of the equipment used to deliver cement from the truck to a particular location at the job site. In operation, once the waste matter is collected, the tag axle assembly is raised to an upright position and in the process the front of the washout bucket contacts the mixing drum and tips over, emptying the waste material into the mixing drum. As a result, waste concrete material can be properly disposed of or salvaged for reuse rather than indiscriminately washed onto the ground at the job site. U.S. Pat. No. 6,464,098 to Elefsrud issued on Oct. 8, 2002, disclosed a method and apparatus for collecting concrete waste from a job site and transporting it back to the cement yard. Again, these inventions do not address the problem of efficiently disposing of or recycling the concrete waste.

Another attempt at recycling excess concrete is found in U.S. Pat. No. 4,154,671 to Borges issued May 15, 1979. In operation, the driver of a cement truck dumps his excess load of cement on a shaker screen, energizes the shaker to separate the rock from the sand into individual bin areas. At the same time an auger located in the sump area of the holding tank conveys the slurry into a pump for transfer to a settling tank where the slurry is separated from the water. The cement, water and slurry collected in the settling tank is used in combination with fresh sand and cement to provide a fresh charge to waiting cement trucks. Sand, cement, water and aggregate previously lost is now recycled and reused rather than being wasted. Again, this is a time consuming and relatively expensive process. Furthermore, it doesn't solve the problem of what to do with the excess concrete at the end of the work day.

One method that does provide for recycling excess concrete from ready-mix concrete trucks involves pouring the wet concrete into molds or forms to specifically to produce concrete shapes suitable for use in forming an artificial reef. U.S. Pat. No. 5,908,265 to Mostkoff issued Jun. 1, 1999 shows an artificial reef module and method which employs ready mix cement trucks with excess load to blend measured amounts of concrete and tire chips. The resultant mixture is jettisoned into an awaiting mold cluster or into molds of other various geometric solid shapes. The concrete molded shapes are then placed in the sea or ocean to form artificial reefs. However, the resultant molded concrete shapes produced by this method, although suitable for use in an artificial reef, would not possess the required strength for use as a structural building material.

Therefore, there remains a need in the art for an efficient and cost effective method for recycling excess wet concrete from ready-mix concrete trucks. The present invention solves this need by providing a system in which residual wet concrete is poured into on-site easily constructed forms to make pre-cast building structures such as ground planks, shoring planks or stack wall planks. Steel reinforcement and lifting handles inserted make the pre-cast structures stronger and easier to manipulate. Once set, the resulting structures are easy to remove from the form and stackable so that they may be stored or displayed for sale.

Various techniques for molding concrete are well-known in the industry. For example U.S. Pat. No. 5,096,648 issued Mar. 17, 1992, to Johnson et al. discloses a mold system for producing paving stones that employs a plurality of slidably mounted molds. Also, U.S. Pat. No. 4,067,941 issued Jan. 10, 1978, disclosed a mold for producing multiple slabs of concrete. However, the conventional techniques for molding concrete into pre-cast structures such as paving stones or simple slabs are not suitable for the contemplated uses of the pre-cast planks molded from the recycled material of the present invention for the following reasons. Historically, the process of removing the hardened concrete structures from molds is a time consuming process, because great care must be taken to ensure that the molded structure is not damaged, and therefore, expensive. The resulting pre-cast structures are not strong enough to be used as ground, shoring or stack wall planks because they are not reinforced. Lastly, the resulting structures are not easily manipulated and stacked because they are not made with integral or attachable lifting handles.

### SUMMARY OF THE INVENTION

The primary object of the present invention is to provide an efficient and cost-effective system, including a method and an apparatus, for recycling wet concrete waste material from ready-mix cement trucks into pre-cast concrete structures using reinforced “residual-collection” molds, and the structures formed thereby.

Yet another object of the present invention is to provide such a system in which the pre-cast reinforced concrete structures are ready-to-use structurally sound materials such as ground planks, shoring planks, trench planks, utility planks, stack wall planks, jersey wall sections, manhole covers, and the like.

The recycling method of the present invention begins with the mixing trucks returning to the plant at day's-end. “Residual-collection” molds are kept on-hand at the plant, and as the ready-mix cement return they evacuate their excess wet concrete into the residual-collection molds. Over the course of days or weeks the mold builds into a completed precast concrete structure. Upon completion, the structure is removed and inventoried, and the process begins anew. In the meantime, the completed structures (such as barrier walls) are sold or leased to customers. This not only avoids the incremental cost associated with the traditional disposal of concrete aggregate, but also produces a supplemental income stream from it.

The “residual-collection” molds of the present invention generally comprise a casting bed for molding concrete into planks or other rectangular shaped structures. The casting beds are comprised of rectangular steel plate flooring, four steel plate perimeter walls, a plurality of lengthwise steel plate dividers, and a plurality of widthwise steel plate dividers. The perimeter walls and the dividers are formed in the shape of isosceles triangular prisms in which the symmetrical sides are comprised of strips of steel plate, stitch welded together along one edge. These angular perimeter walls and dividers are necessary to ensure that the cast form is easily removed from the mold once set. Along the far edges strips of steel plate are tack welded to metal spacers to form the bottom of the triangle. The perimeter walls are tack welded along the perimeter of the steel plate flooring to form an enclosed rectangular form. The dividers are then tack welded to the flooring as necessary to create the desired molds for the pre-cast structures. The casting beds may be portable or stationery.

In one particular embodiment of the casting bed, the steel plate flooring is comprised of 48′ by 8′, ¼′ steel plate. The perimeter walls and dividers are formed with two 6″ wide ¼″ steel flatbars cut to the desired length and a 1″ spacer. In order to form planks, the optimal spacing for the longitudinal dividers is every 1′. The optimal spacing for the horizontal dividers is 12′. This results in a 1′ by 12′ by ½′ mold which holds ¼ cubic yards of wet concrete. For a plank of this size reinforcement is provided by a pre-formed reinforcing cage constructed from 2 layers of conventional welded wire mesh each layer supported by two 2″ continuous slab bolsters.

An additional object of the present invention is to provide an integral or attachable lifting handle or ring for easy removal of the pre-cast structure from the form system and for easy manipulation to and around the work site. In one embodiment either a bent rebar or pre-engineered PVC or plastic handle, capable of holding up to 300% of the pre-cast structure's weight, is wired to the pre-formed reinforcing cage and formed as integral part of the plank. Once the structure is in place at the work site bolt cutters may be used to remove the handle as necessary. In another embodiment the handle would be similarly formed as an integral part of the pre-cast structure, but the handle will also be hinged at the surface of the structure such that when it is not in use it will lie flat. In another embodiment a plugged PVC sleeve is used to form a pre-cast hole in the structure. Once the pre-cast structure is set, the PVC sleeve is removed and a wedge anchored swage eye-bolt is inserted and attached for use as a handle.

Yet another object of the present invention is to provide pre-cast structures with integral patterns, textures or colors. Specifically, wet cement is poured into the mold, and is then screeded and floated so that the surface of the cement is smooth and suitable for taking a finish (i.e. pattern, texture, or color). A selected patterned or texture is imbedded into the cement slump by a heavy roller of a predetermined length rolled over the top of the form. The roller is grooved on its outer edges and at pre-determined intervals to guide the roller along the sides and/or dividers to ensure that the pattern is aligned and at a constant depth. Other textures or colors may be added at this stage by conventional methods such as applying exposed aggregate or brick dust.

An additional object of the present invention is to provide two types of casting beds, one for permanent installation at the cement yard and the other portable for use at work sites. In the preferred embodiment permanently installed casting beds are anchored to an imbedded concrete curb perimeter surrounding a compacted 6″ to 8″ sub-grade foundation with a 4″ sand or gravel top-layer. The casting bed flooring is anchored (i.e. by bolting) on top of steel I-beams and further supported by a plurality of intermediate support joists anchored between the I-beams.

### BRIEF DESCRIPTION OF THE DRAWINGS

FIG. 1 is an operational diagram illustrating the method of the present invention.

FIG. 2 is a plan view of the mold (or “form”) of the present invention drawn to scale.

FIG. 3 is a vertical cross section end view of the form of the present invention drawn to scale. The drawing is divided into two halves, the left 3A and the right half 3B. 3A (left half) illustrates the preferred embodiment configured for permanent installation. 3B (right half) illustrates the preferred embodiment configured for portable use.

FIG. 4 is an exploded cross section drawn to scale illustrating the structure of the form dividers/sides.

FIG. 5A is a cross section of one embodiment of a pre-cast plank drawn to scale illustrating the reinforcing cage and an integral bent rebar type lifting handle.

FIG. 5B is a cross section of one embodiment of a pre-cast plank drawn to scale illustrating an integral pre-engineered PVC type lifting handle.

FIG. 5C is a cross section of one embodiment of a pre-cast plank drawn to scale illustrating a method and apparatus of an attachable wedge anchor eyebolt type lifting handle.

FIGS. 5D (1) and (2) are front and side view cross sections, respectively, of one embodiment of a pre-cast plank drawn to scale illustrating an integral or attached hinged lifting handle.

FIG. 6 is as an operational drawing illustrating the use of a textured roller in conjunction with the form system of the present invention.

FIG. 7 is an drawing illustrating the preferred pre-cast reinforced jersey wall of the present invention.

### DETAILED DESCRIPTION

The present invention is a system, including a method and apparatus, for recycling excess or residual wet concrete remaining in ready-mix concrete trucks after completion of a job.

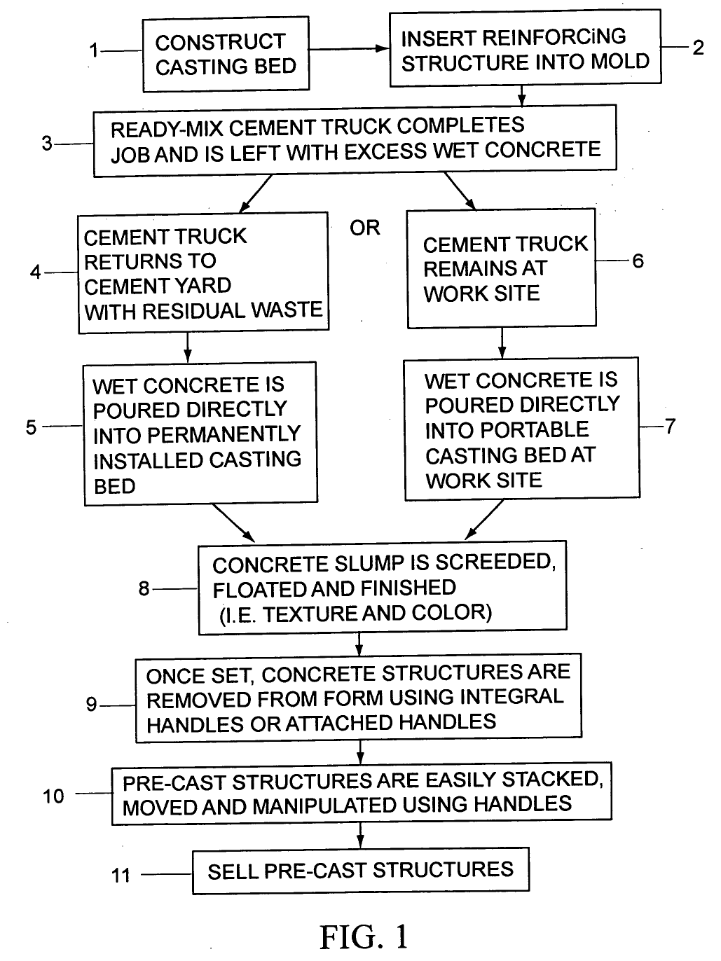

The recycling method of the present invention begins with the mixing trucks returning to the plant at day's-end. Portable or stationary “residual-collection” molds are kept on-hand at the plant, and as the ready-mix cement return they evacuate their excess wet concrete into the residual-collection molds. Over the course of days or weeks the mold builds into a completed precast concrete structure. Upon completion, the structure is removed and inventoried, and the process begins anew. In the meantime, the completed structures (such as barrier walls) are sold or leased to customers. This not only avoids the incremental cost associated with the traditional disposal of concrete aggregate, but also produces a supplemental income stream from it. More specifically, and with reference to FIG. 1, the method is comprised of the following steps: (1) constructing the casting bed with desired mold dimensions, and (2) inserting reinforcing structures into the molds; (3) in the event that a ready-mix concrete truck is left with excess or residual wet concrete upon completion of a job, the truck (4) returns to the yard truck with excess or residual wet concrete, and (5) the excess wet concrete is poured directly into the stationery casting bed of the present invention. Alternatively, the truck (6) may stay at the worksite with excess or residual wet concrete, and (7) the excess wet concrete is poured directly into the portable casting bed of the present invention which is set up at a convenient location (i.e. the work site). In either case at (8) The wet concrete is screeded, floated and finished. (9) Once set, the reinforced pre-cast structures (i.e. planks) are removed from the casting bed using integral or attached lifting handles. At step (10), the integral or attached lifting handles make these pre-cast structures easy to move, stack and manipulate for storage. The pre-cast structures are then sold at (11) for use in a variety construction projects (described below). Lastly, once the pre-cast structures are in position for use, the handles may be easily cut or detached as necessary.

The residual-collection molds of the present invention includes a casting bed to produce pre-cast structures including reinforced ready-to-use planks and barrier walls. The planks may be ground planks, shoring planks, trench planks, stack wall planks, and the like. For example, these planks may be used as the surface material for temporary roads instead of or in addition to gravel, for additional support under the high traffic areas of paved roads, for temporary vehicle bridges over irrigation ditches, for sidewalks, for driveways, etc.

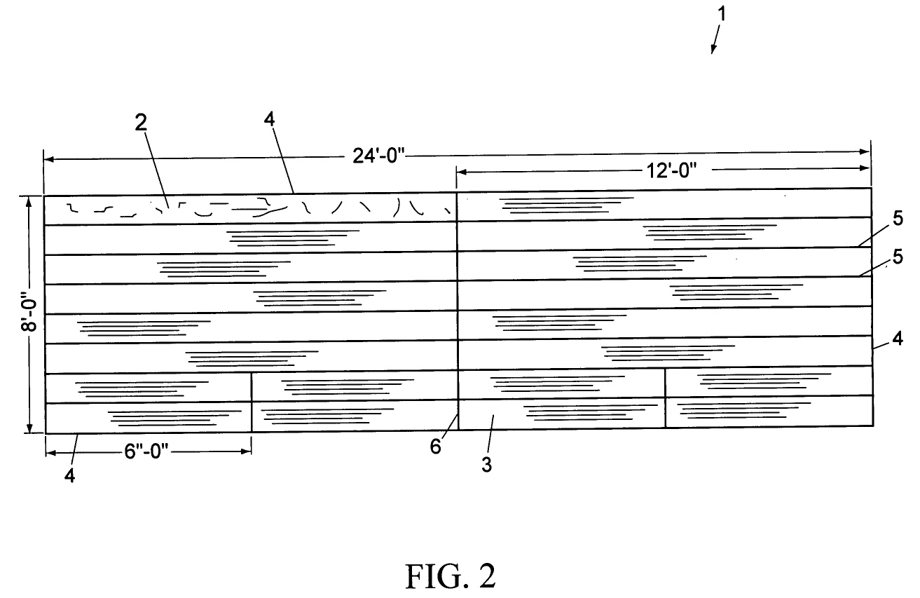

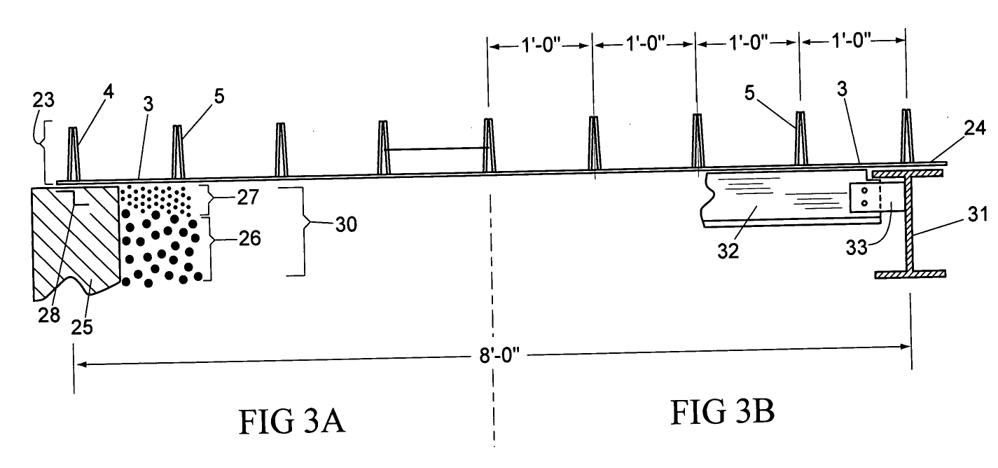

Referring to the top view of FIG. 2, the casting bed 1 of the present invention is adapted for molding pre-cast structures such as, for example, concrete planks 2. The casting bed is generally comprised of steel plate flooring 3, four surrounding steel plate perimeter walls 4, a plurality of lengthwise steel plate dividers 5, and at least one widthwise steel plate divider 6. Also, as mentioned previously the present invention makes use of two types of casting beds 1, fixed and portable. The type here will determine the support structure employed for the casting bed. FIG. 3 is divided into two halves, 3A (left half) illustrating the preferred embodiment for permanent installation, and 3B (right half) for portable use. Referring to FIG. 3A, the permanently installed casting bed 23 is for use at a cement yard or some other conveniently located site where it is anticipated that the casting bed 1 will be in use for a prolonged period of time. This casting bed 23 is permanently attached or otherwise secured to a support structure 25 imbedded in the ground and is further supported by a foundation 30. In the preferred embodiment this permanently installed casting beds 23 includes a concrete curb 25 with approximately the same length and width dimensions as the flooring 3 is imbedded into the ground. The flooring 3 is bolted or otherwise attached to an anchor 28 imbedded in the curb 25. This concrete curb 25 also serves as the perimeter walls for a supporting foundation 30 comprised of a compacted 6″ to 8″ sub-grade foundation 26 with a 4″ sand or gravel top-layer 27.

Referring to FIG. 3B, the second type of casting bed is a portable casting bed 24 for use at work sites or the like. The portable casting bed 24 is designed for easy transport and assembly at work sites. The casting bed flooring 3 is anchored (i.e. by bolting) on top of support beams 31, corresponding to the four sides of the rectangular flooring 3. The flooring 3 is further supported by a plurality of intermediate support joists 32 running the width of the flooring 3 between parallel support beams 31. In the preferred embodiment the portable casting bed 24 is bolted to steel I-beams 31. The I-beams 31 are further comprised of a plurality of steel tabs 33 welded or otherwise attached at predetermined intervals along the length of the I-beams. The intermediate support joists 32 are bolted or otherwise attached to the corresponding tabs 33 on parallel I-beams 31.

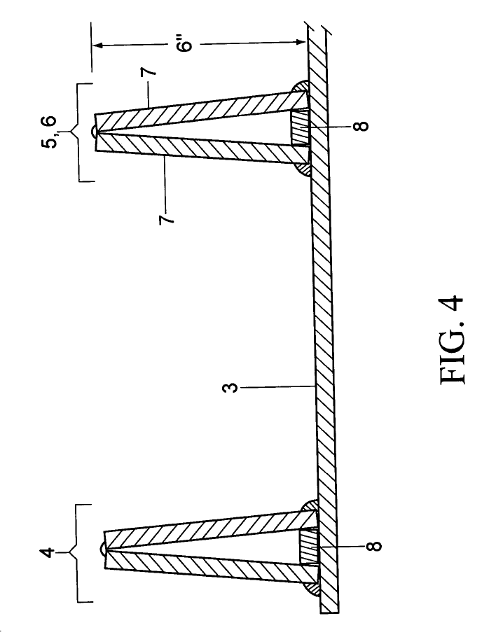

In either case (fixed or portable), as shown in the side view of FIG. 4 the perimeter walls 4 and the dividers 5, 6 are identical and are formed in the shape of isosceles triangular prisms in which the symmetrical sides 7 of the triangle are comprised of strips of steel plate, stitch welded together along one edge. The angled perimeter walls 4 and dividers 5, 6 are necessary to ensure that the cast form is easily removed from the mold once set. The far edges of the strips of steel plate are tack welded to metal spacers to form the bottom 8 of the triangle. The perimeter walls 4 are tack welded along the perimeter of the steel plate flooring to form an enclosed rectangular form. The dividers 5, 6 are then tack welded to the flooring as necessary to create the desired molds for the pre-cast structures.

While the casting bed 1 of the present invention is described herein as being constructed of steel plate materials welded together, those skilled in the art will recognize that various other materials (i.e. heavy duty plastic, wood, etc.) may also be suitable and cost efficient for constructing the present form system. Those skilled in the art will also recognize that, depending on the materials used, various other methods of connecting the components are also anticipated.

It is common for cement trucks to complete a project and still have more than a quarter cubic yard of excess wet cement left in the truck. Therefore, the optimal casting bed will be set up to produce 1′ by 12′ by ½′ concrete planks. A concrete plank 2 of this size requires ¼ cubic yards of wet concrete. Additionally, planks of this size are small enough to be easily manipulated, while still limiting the relative amount of labor required for installation compared to other pre-cast structures such as bricks, or pavers.

In the preferred embodiment the steel plate flooring 3 (FIG. 4) is comprised of 48′ by 8′, ¼′ steel plate. The perimeter walls 4 and dividers 5, 6 are formed with two 6″ wide ¼″ steel flatbars (steel plate strips) cut to the desired length with a 1″ spacer to create the bottom 8 of the triangle. In order to form these optimal 1′ by 12′ by ½′ planks 2, the optimal spacing for the lengthwise dividers 5 is every 1′. The optimal spacing for the horizontal dividers 6 is 12′. While the 1′ by 12′ by ½′ plank size described above is the preferred pre-cast reinforcing structure, the casting bed 1 of the present invention may be modified to produce other structures with varying dimensions. For example, planks may be molded with dimensions of a 2′ by 12′ by ½′ (approximately ½ cubic yards of wet concrete) or 3′ by 24′ by 8″ (approximately 1¾ cubic yards of wet concrete). Instead of planks, reinforced concrete plates can be molded to form square man-hole covers (4′ by 4′ by ½′) or ½′ thick utility plates. The proposed utility plates can be used to temporarily patch road surfaces instead of conventional steel plates.

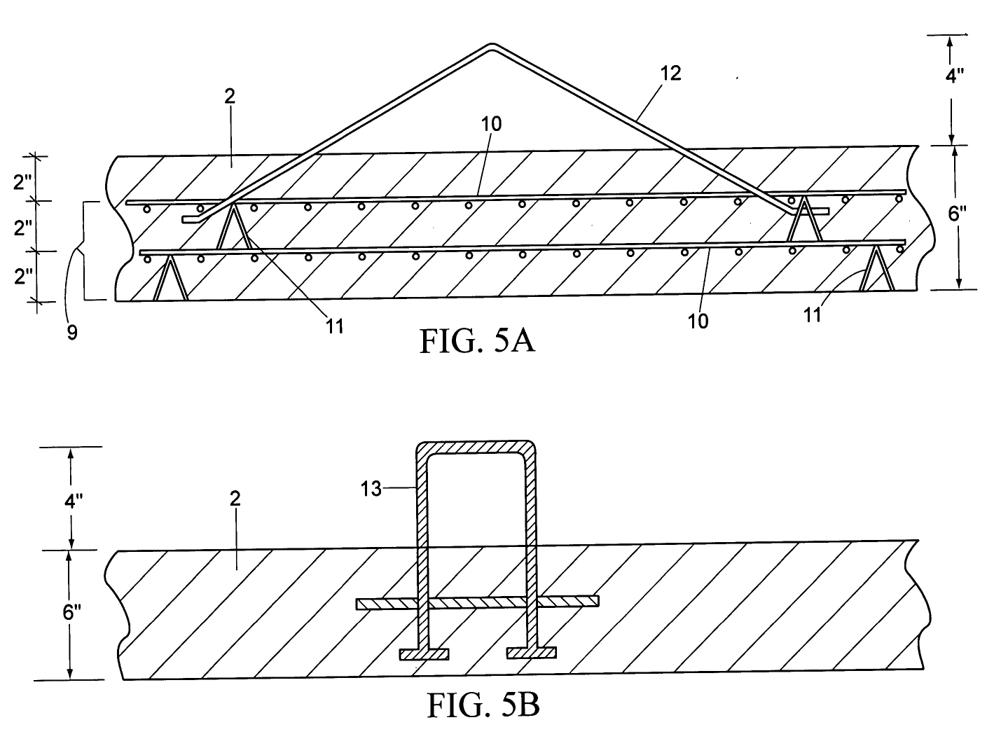

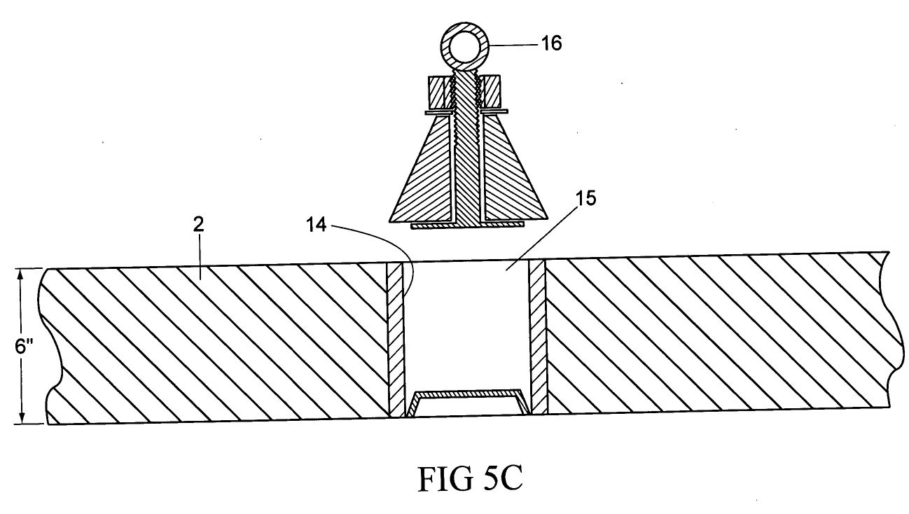

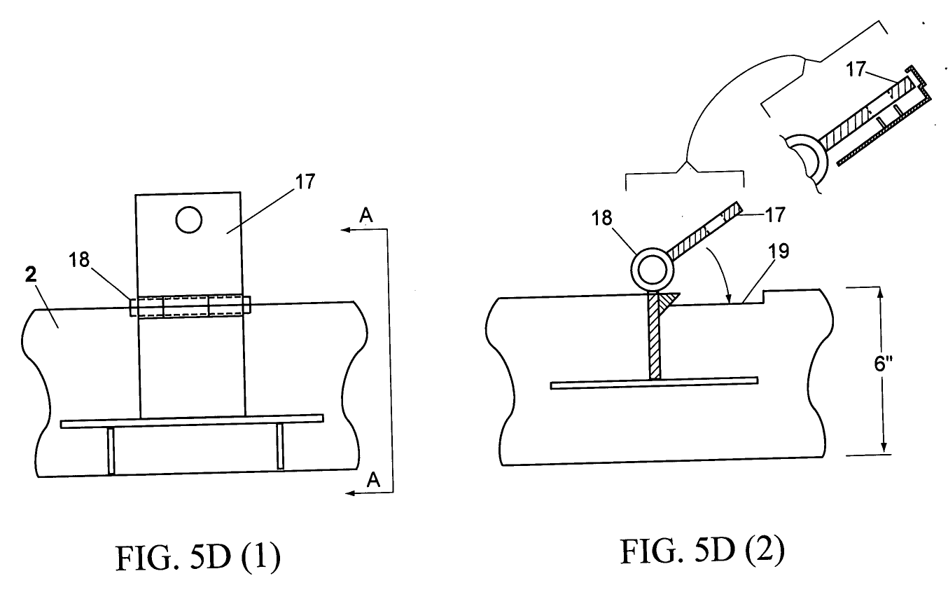

In order for the planks 2 of the present invention to be suitable as pre-cast structural use planks, they are formed with integral reinforcement, such as welded wire mesh or steel rebar. For a plank of this size reinforcement is optimally provided by a pre-formed reinforcing cage 9 (as shown in FIG. 5A). This reinforcing cage 9 is constructed from 2 layers of conventional welded wire reinforcing mesh 10, each layer supported by two 2″ continuous slab bolsters 11. Those skilled in the art will appreciate that other forms of concrete reinforcement may also be suitable for the purpose of reinforcing the planks of the present invention (i.e. steel rebar rather than mesh 10). This reinforcing cage 9 is placed into the mold with the wet concrete and provides strength once the concrete is set.

Additionally, in order for the planks 2 of the present invention to be easily removed from the casting bed 1 and also easily transferred to and manipulated around the work site, the planks are formed with one or more integral or attachable lifting handles. For safety reasons, the lifting handles should be rated to hold up to 300% of the plank's weight. In one embodiment either a bent rebar lifting handle 12 (See FIG. 5A) or pre-engineered PVC or plastic handle 13 (See FIG. 5B), is wired or otherwise attached to the pre-formed reinforcing cage 9 and formed as integral part of the plank. Practically, the lifting handle 12, 13 should extend approximately 4 inches above the plank 2 so that a standard hook connected to a piece of lifting equipment (i.e. a front loader with boom) may be used to lift and move the plank. If necessary for structural or aesthetic reasons, the lifting handles 12, 13 may be easily removed by bolt cutters once in place.

In another embodiment of the plank of the present invention, as shown in FIG. 5C, the lifting handle 16 is removably attached to the plank. An attachable handle is created by placing a plugged PVC sleeve 14 into poured wet cement at the desired handle location. This sleeve 14 is used to form a pre-cast hole 15 in the plank. Once the plank is set, the PVC sleeve 14 is removed and a wedge anchored swage eye-bolt 16 is inserted and attached for use as a handle. This is the preferred handle for planks that are finished with textures, patterns, and/or colors, as discussed below, because once the plank is in place (i.e. as a sidewalk or driveway plank), the handle may be removed and the pre-cast hole 15 may be filled in and camouflaged.

In yet another embodiment of the plank of the present invention, as shown in FIGS. 5D(1) and (2), a lifting handle 17 would be either integrally attached as with the rebar 12 or pre-engineered PVC 13 handles or removably attached as with the wedge anchored eye-bolt 16. This lifting handle 17 is further comprised of a hinge 18 at the surface of the plank 2. Additionally, after the wet concrete is poured a piece of material the approximate size and shape of hinged lifting handle 17 is placed at a predetermined position on the surface of the wet cement to create a void 19 in the surface of the cement. This void 19 permits the lifting handle 17 to pivot at its hinge 18 and lie flat creating smooth surface. This type of handle is ideal for utility or trench planks used as temporary road surfaces, often requiring easy and efficient removal from one position to another.

Another object of the present invention is to provide finished pre-cast reinforced planks 2 with integral patterns, textures or colors. Such planks would be ideal for driveway surfaces, sidewalks, garden retaining walls, and the like because they are aesthetically pleasing, extremely strong and require less labor to install than traditional pavers or stones. After the wet cement is poured into the form system, screeded and floated the surface of the cement is smooth and suitable for taking a finish (i.e. pattern, texture, or color). Textures or colors may be added at this stage by conventional methods such as applying exposed aggregate or brick dust or by simply running a broom over the wet concrete.

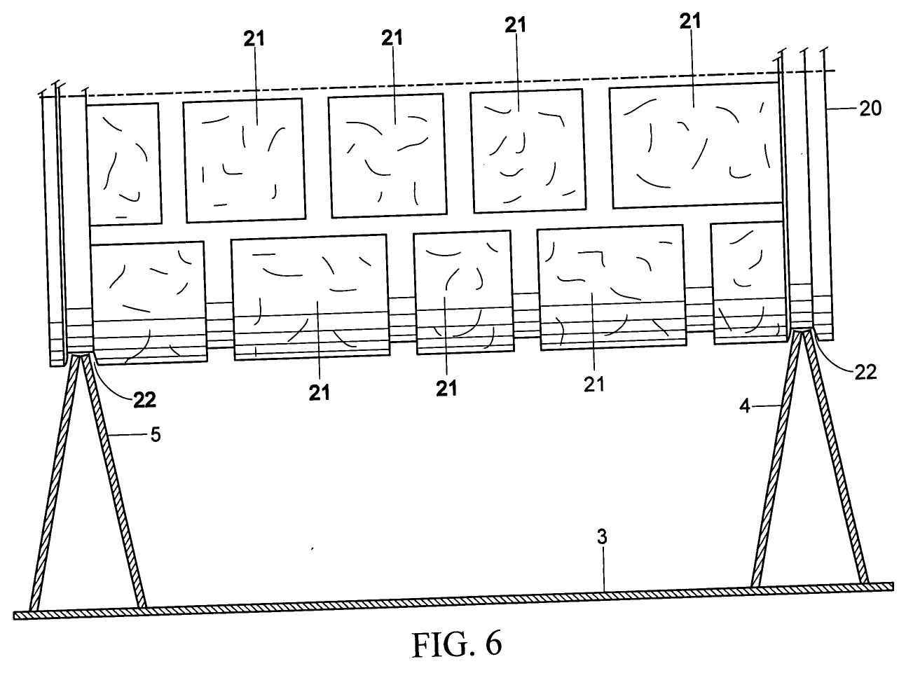

Refering to FIG. 6, a selected patterned or texture 21 (i.e. layered brick-like pattern) may be also be imbedded into the cement slump by a heavy roller 20 imprinted with the pattern 21. The roller 20 of a predetermined length is rolled over the top of the form, imprinting the pattern as it is rolled. The roller 20 includes grooves 22 on its outer edges and, if necessary, at predetermined intervals to guide the rollers along the perimeter walls or dividers to ensure that the pattern is aligned and at a constant depth. In order to make the preferred planks of the present invention (1′ by 12′ by ½′), the predetermined interval between grooves 22 is approximately 1′ foot so that the roller may be guided along the perimeter walls 4 and the lengthwise dividers 5.

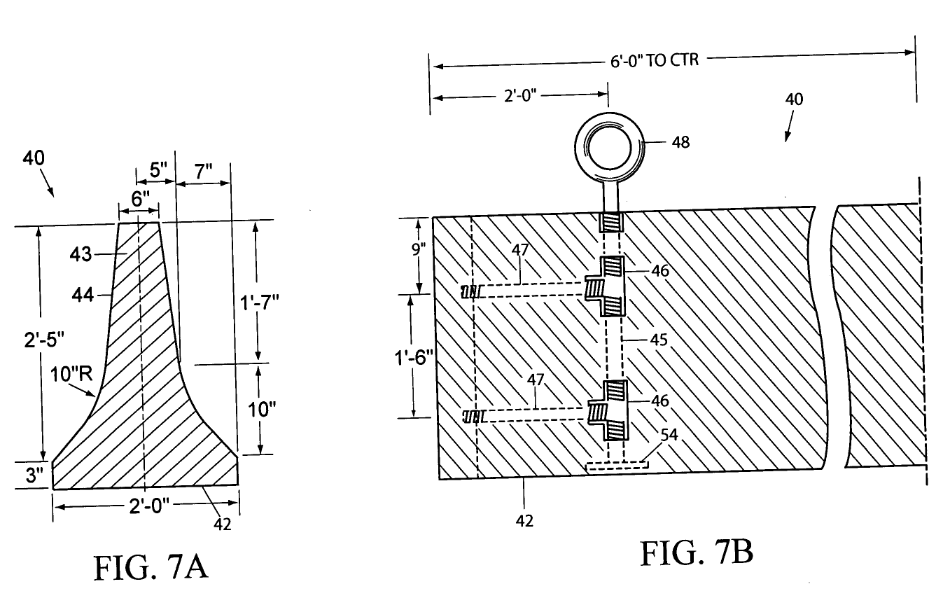

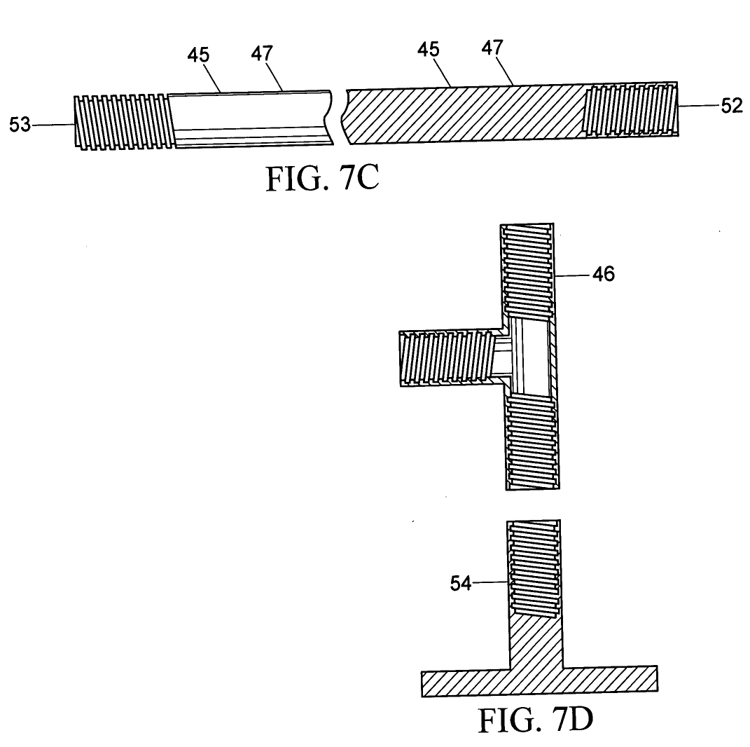

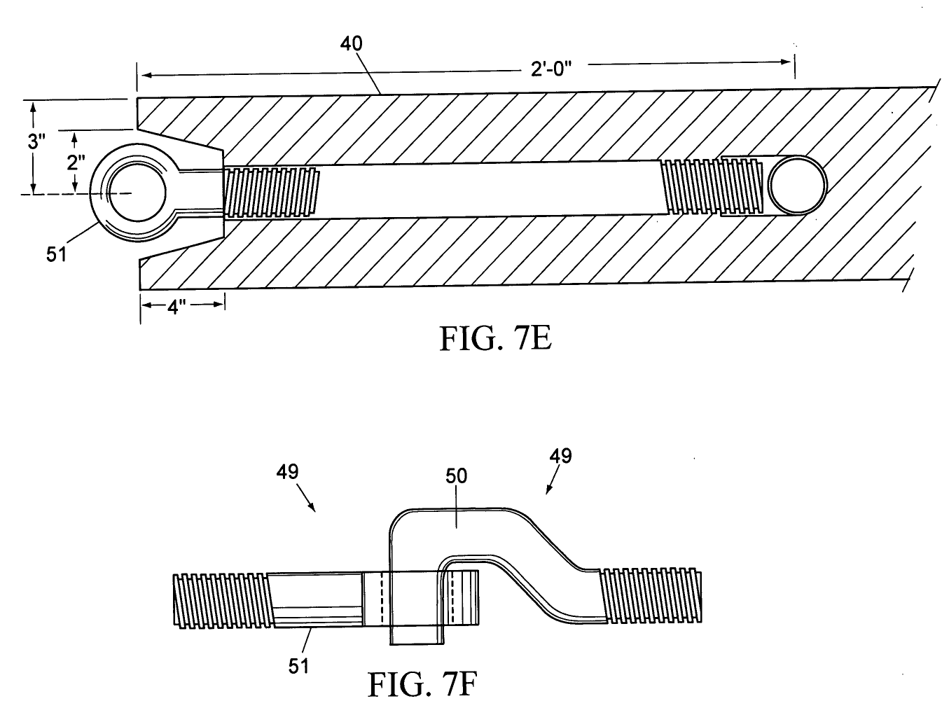

Lastly, using a similar casting method (residual-collection mold not shown), the inventor anticipates that the present method and system may also be used to mold pre-cast concrete highway barriers or jersey walls from the excess residual concrete discussed throughout this application. FIGS. 7A-F illustrate a cast cement structure molded for use as a highway barrier wall, also known as a jersey wall, section including an integral lifting handle and attachment mechanism. In this embodiment of the present invention, excess wet concrete waste material from ready-mix cement trucks would be poured into permanently installed or portable form systems designed to create highway barrier wall sections 40 (jersey walls).

Referring to FIG. 7A, the preferred jersey wall section 40 structure would include a top 41, a base 42, two opposing symmetrical ends 43 and two opposing symmetrical sides 44. The height of the wall is approximately 2′, 8″. The width at the base 42 is approximately 2′ and the width at the top 41 is approximately 6″. The length of each wall section is ideally 12′.

Referring to FIG. 7B, in the preferred embodiment of the present invention, there is cast into each wall section 40 two vertical anchored lifting rods 45 that extend to from the base 42 to the top 41 surface of the wall 40. Each of the two rods 45 are positioned approximately 2′ from the opposing ends 43 and centered. Connected to each lifting rod 45 by connector 46 are two horizontal connecting rods 47 which extend to the surface of either one or the other end 43. The horizontal connecting rods 47 of each wall section 40 are on the same horizontal plane.

Referring to FIGS. 7C-D, the surface ends 52 of rods 45 and 47 are a threaded socket for easy attachment of a lifting handle 48 and connecting mechanism 49, respectively. The opposite ends 53 of rods 45 and 47 are threaded for attachment to an anchor 54 or connector 46. A lifting handle 48 (See FIG. 7B), such as an eyebolt, may be screwed into the surface end 52 of lifting rod 45. A connecting mechanism 49 is screwed into the surfaced end 52 of connecting rod 47 and is used to secure the sections of jersey wall 40 together (See FIGS. 7E-F).

The preferred connecting mechanism 49 of the present invention is comprised of a hook 50 and eyebolt 51, which may be either pre-assembled or attached on site as the sections are positioned. However, those skilled in the art will recognize that other attachment mechanisms 49 may be suitable for securing two or more jersey wall sections together.

The preferred material for the rods (45 and 47), the lifting handle 48 and the connecting mechanism 49 is recycled PVC. However, those skilled in the art will recognize that other suitable materials may be used.

The jersey wall section 40 is described herein with two vertical lifting rods 45, each with two connecting rods 47. However, those skilled in the art will recognize that depending upon the size of the wall section and upon the required strength of the barrier the number of lifting rods and connecting rods may vary.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A method for recycling of excess wet concrete (slump) from ready-mix cement trucks, comprising the steps of:
constructing a casting bed, comprising flooring, a perimeter wall bounding said flooring to create a molding receptacle, and a plurality of dividers within said perimeter wall to subdivide said molding receptacle into a plurality of molding compartments to make a plurality of pre-cast cement structures;
inserting a reinforcing structure into each molding compartment;
pouring excess slump from ready-mix concrete trucks into said casting bed at the end of each workday;
screeding, floating and finishing said slump;
removing said reinforced pre-cast structures with integral reinforcing structures from said casting bed;
storing said reinforced pre-cast structures for sale or lease.

2. The method of claim 1, wherein said pre-cast structures are reinforced planks with integral or removably attached lifting handles.

3. The method of claim 1, wherein said reinforced structures are adapted for use in any one of the group comprising sidewalks, driveways, temporary road ways, temporary ditch and trench bridges, manhole covers, jersey walls and foundation for paved roads beneath heavy traffic areas.

4. A precast roadway concrete structure formed by recycling wet surplus concrete in cement trucks returning from a worksite, said recycling comprising progressively emptying surplus slump concrete into a residual-collection mold over the course of time until the recycled concrete builds into one or more completed precast barrier sections, said residual-collection mold further comprising a casting bed including a rectangular steel plate floor, two steel plate perimeter walls, a plurality of lengthwise steel internal walls, and a plurality of widthwise steel plate bulkheads.

5. The precast roadway concrete structure according to claim 4, wherein said precast roadway barrier section further comprises a concrete roadway barrier section molded and hardened in said casting bed and having at least one lifting mechanism embedded therein, and an integral reinforcement structure embedded throughout said concrete barrier section.

6. The precast roadway concrete structure according to claim 4, wherein said precast roadway barrier section further comprises a concrete plank molded and hardened in said casting bed and an integral reinforcement structure embedded throughout said concrete plank.

7. The precast roadway concrete structure according to claim 4, further comprising at least one pattern embossed in a surface of concrete structure.

8. The precast concrete roadway barrier section according to claim 5, wherein said barrier section further comprises recesses formed at each end of said barrier section.

9. The precast concrete roadway barrier section according to claim 5, wherein each of said at least one lifting mechanisms further comprises;
an anchoring member;
a first three-way connector detachably attached at a first end to said anchor plate;
a first connector rod detachably attached at a first end to a second end of said first three-way connector;
a second connector rod detachably attached at a first end to a third end of said first three-way connector;
a second three-way connector detachably attached at a first end to a second end of said second connector rod;
a third connector rod detachably attached at a first end to a second end of said second three-way connector; and
a fourth connector rod detachably attached at a first end to a third end of said second three-way connector.

10. The precast concrete roadway barrier section according to claim 9, wherein said anchoring member is formed with Acme threads at one end.

11. The precast concrete roadway barrier section according to claim 9, wherein said anchoring member, said first and said second three-way connectors, and said first, second, third, and fourth connector rods are fabricated of recycled PVC plastic.

12. A precast concrete roadway structure formed from two or more precast concrete roadway sections, each formed by recycling wet surplus concrete in cement trucks returning from a worksite, said recycling comprising progressively emptying said surplus concrete into a single residual-collection mold over the course of time until the recycled concrete builds into two or more completed precast concrete roadway section, said residual-collection mold further comprising a casting bed including a rectangular steel plate floor, perimeter walls, and at least one divider, each of said precast concrete roadway concrete sections being molded and hardened in said casting bed and further comprising at least one lifting/assembly system embedded therein, an integral reinforcement structure embedded throughout each section, and connector at each end of each precast concrete roadway sections for joining said sections together.

13. The precast concrete roadway structure according to claim 12, wherein each of said precast concrete roadway sections further comprise a plank.

14. The precast concrete plank according to claim 13, wherein said plurality of dividers each comprise two flat section joined together along one edge to form a triangular-tapered cross-section.

15. The precast concrete plank according to claim 14, wherein said four steel plate perimeter walls are angled outwardly away from said floor for easier removal of said concrete plank.

16. The precast concrete roadway structure according to claim 12, wherein each of said precast concrete roadway sections further comprise a barrier wall.

17. A method for recycling of excess wet concrete (slump) from ready-mix cement trucks, comprising the steps of:
pouring excess slump from ready-mix concrete trucks into a casting bed at the end of each workday, said casting bed comprising flooring, a perimeter wall bounding said flooring to create a molding receptacle, and a plurality of dividers within said perimeter wall to subdivide said molding receptacle into a plurality of molding compartments to make a plurality of pre-cast cement structures;
screeding, floating and finishing said slump;
removing said reinforced pre-cast structures from said casting bed;
storing said reinforced pre-cast structures for sale or lease.

18. The method according to claim 17, further comprising a step of inserting a reinforcing structure into each molding compartment prior to said pouring step.

19. The method of claim 18, further comprising a step of inserting a lifting handle into each molding compartment during said pouring step.
